(19) United States
(12) Patent Application Publication
(10) Pub. No.: US 2026/0253760 A1
(43) Pub. Date: Aug. 27, 2026

(54) HIGH POWER AND HIGH PRECISION X-RAY SPECTROSCOPE

(71) Applicant: Advanced Fusion Systems LLC, Newtown, CT (US)

(72) Inventor: Curtis A. Birnbach, Port Chester, NY (US)

(73) Assignee: Advanced Fusion Systems LLC, Newtown, CT (US)

(21) Appl. No.: 19/531,465

(22) Filed: Feb. 5, 2026

Related U.S. Application Data
(60) Provisional application No. 63/755,641, filed on Feb. 7, 2025.

(51) Int. Cl. G21K 1/06

(52) U.S. Cl. CPC G21K 1/06

(57) ABSTRACT

An X-ray spectrographic apparatus for providing a high-precision spectral line having a housing coupled to an X-ray generation device which includes an input window for receiving an X-ray beam from an X-ray generation device, an adjustable diffractive element positioned to receive the X-ray beam from the input window and to diffract the X-ray beam such that a substantial portion of the X-ray beam is directed along an orientation associated with the spectral line, a variable aperture positioned along the defined orientation so as to receive and pass the portion of the X-ray beam diffracted along the orientation of the spectral line and to block X-rays that are not of the desired spectral line, an output window positioned opposite from the aperture with respect to the diffractive element so as to receive the X-ray beam that travels through the aperture, and an adjustable mount for holding and positioning the diffractive element.

### CROSS-REFERENCE TO RELATED PATENT APPLICATIONS

This application is based on and claims priority to U.S. Provisional Patent Application 63/755,641, filed Feb. 7, 2025, the entire contents of which is incorporated by reference herein as if expressly set forth in its respective entirety herein.

### FIELD OF THE INVENTION

The present disclosure relates to spectroscopy and more particularly relates to a method and apparatus for achieving highly spectrally pure monochromatic X-ray radiation for semiconductor microlithography and other applications.

### DEFINITIONS

Beam Dump: A component designed to capture unwanted forms of electromagnetic radiation and to manage their ultimate removal.

Differential Gas Window (DGW): A mechanical component that provides an interface means between that lasant and the environment of the spectroscopic filter of the present invention.

Diffractive Element: An optical-type component, typically either aa grating structure or a bent crystal with known atomic dimensions.

Interferometer: An optical instrument which is used as a measuring means to precisely control the X, Y, and Z location of the diffractive element within the housing of the present invention. An interferometer works by colliding beams of coherent light to create “Interference Fringes” which can then be counted and used as a measuring device.

Lasant: Active chemical to be stimulated (lased) to produce monochromatic emissions.

Low Thermal Expansion Alloy: A metal with very low coefficients of thermal expansion in range of less than 1.8 to approximately 9 x 10-6 per °C (1.0 to approximately 5.0 x 10-6 per °F).

Residual Gas Analyzer (RGA): The RGA is a spectroscopic instrument, specifically designed to atomically analyze gases to determine their atomic content.

Spectral Dispersion: Spectral dispersion is the separation of light into its component colors, or spectrum. The dispersion can be achieved by either diffractive (gratings) or transmissive (prisms) means.

Total Ionization: The process of stripping an atom of all of its electrons.

### BACKGROUND OF THE INVENTION

In the quest to advance the art of semiconductor microlithography, light sources of progressively shorter wavelengths have been employed. However, the underlying technological principles of the current generation of lithography systems is approaching its minimum practical limit in terms of frequency.

One of the major complicating issues is the fact that highly monochromatic light is needed at a considerable flux to expose photoresist. FIG. 1 is a graph that depicts the spectral output of totally ionized Nitrogen. Both a theoretical spectrum and an experimental spectrum are shown. See: K-Shell X-Ray Spectroscopy of Atomic Nitrogen; M. M. Sant’Anna, A. S. Schlacter, G. Orwall, W. C. Stolle, D. W. Londe and B. M.McLaughlin; PhysRev.Lett 107. 033001 _ (Published 11 July 2011). It can be discerned in the graph that there is a strong spectral line at about 396 eV. The are also a number of other spectral lines of varying intensities that are produced under these conditions. It is desirable, therefore, to employ a means of spectral filtration. However, at the frequencies involved (396eV = 3.13nM), achieving spectral filtration is a non-trivial activity. Issues such as absorption, scatter, and other degrading factors force certain design constraints.

While operating the working area of the system under either vacuum or helium atmosphere aids in reducing absorption, scattering by the output window(s) is typically more challenging to avoid.

There is therefore a need for a spectroscopic device that provides high precision, particularly for high-power applications such as semiconductor fabrication processes such as X-ray lithography where stable operation in a high thermal flux environment is essential.

### SUMMARY OF THE INVENTION

The present disclosure describes an X-ray spectrographic apparatus for providing a high-power, high-precision desired spectral line, The apparatus comprises a housing coupled to an X-ray generation device. The housing includes an input window for receiving an X-ray beam from an X-ray generation device, an adjustable diffractive element positioned to receive the X-ray beam from the input window and to diffract the X-ray beam such that a substantial portion of the X-ray beam is directed along a defined orientation associated with the desired spectral line. A variable aperture is positioned with respect to the diffractive element along the defined orientation so as to receive and pass the portion of the X-ray beam diffracted along the defined orientation of the desired spectral line and to block X-rays that are not of the desired spectral line. An output window is positioned opposite from the aperture with respect to the diffractive element so as to receive the X-ray beam that travels through the aperture, and an adjustable mount for holding and positioning the diffractive element.

In another aspect the present disclosure describes a method for providing a high power, high-precision desired spectral line. The method comprises receiving an X-ray beam from an X-ray generation device, diffracting the received X-ray beam using a diffractive element, such that a substantial portion of the X-ray beam is directed along an orientation associated with the desired spectral line, precisely adjusting an alignment of the diffractive element, receiving the X-ray beam directed along the orientation associated with the desired spectral line at a variable aperture, blocking parts of the X-ray beam that are not precisely of the spectral line at the by adjusting an opening and position of the aperture, outputting the desired spectral line and regulating a temperature of the diffractive element, variable aperture and beam dump to preserve dimensions and alignment.

### BRIEF DESCRIPTION OF THE DRAWINGS

FIG. 1 is a graph that depicts the spectral output of totally ionized Nitrogen.

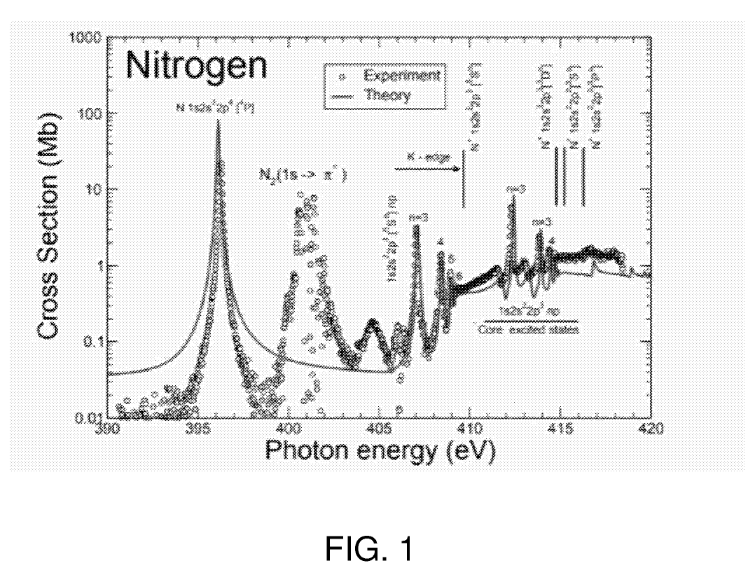

FIG. 2 is an axial cross-sectional view of an X-ray generation device and appended X-ray spectroscopic device according to an embodiment of the present disclosure.

FIG. 3 is an enlarged view of an embodiment of the X-ray spectroscopic device shown in FIG. 2.

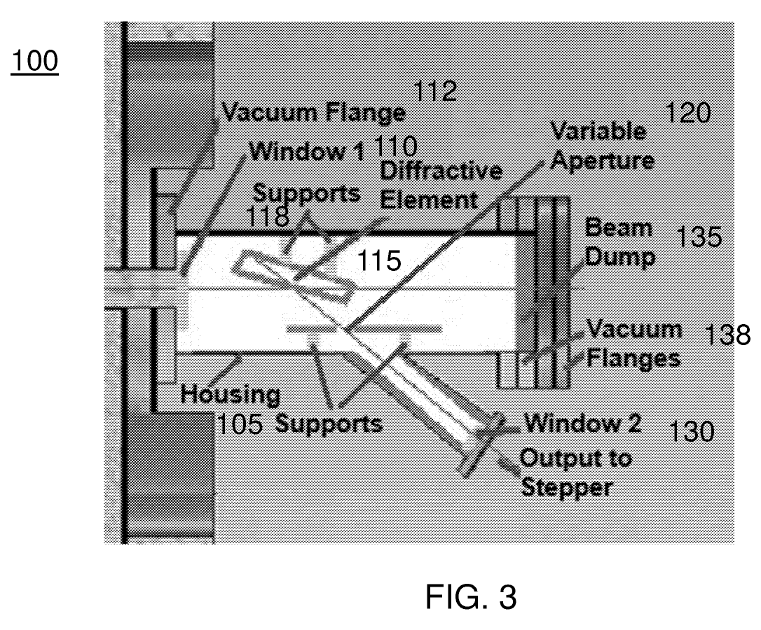

### DETAILED DESCRIPTION OF CERTAIN EMBODIMENTS OF THE INVENTION

The present disclosure describes an X-ray spectroscopic system designed specifically to operate in an extremely high photon flux environment, such as is found in semiconductor manufacturing equipment and other laboratory instruments The system is designed to: receive an input X-ray beam having some degree of divergence (e.g., 0.001⁰ to 45⁰); cause a spectral dispersion of the input beam using a diffractive element; and then narrow select the desired line in the dispersed beam by means of a variable aperture to only allow the desired portion of the spectrum to go to the output.

The remaining portions of the input beam are absorbed by either the beam dump or the variable aperture. It is noted that the diffractive element, the variable aperture, windows, and the beam dump are all provided with individual circulating liquid cooling means to allow control of their respective temperatures. It is particularly important to regulate the temperature of the diffractive element at or near a constant temperature to minimize or eliminate thermal expansion of this element The thermal energy absorbed by the diffractive element is removed by the circulating liquid cooling mechanism. and the diffractive element held at a constant temperature to minimize or eliminate thermal expansion of this element. It is noted that if helium is used as a non-absorbing material within the housing, it too must be circulated and cooled in this process. It is noted that the circulating helium does provide some amount of additional heat transfer.

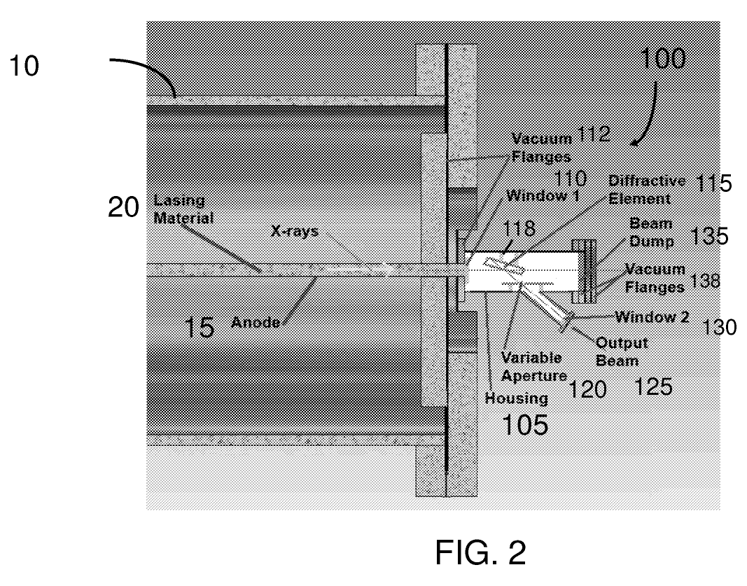

FIG. 2 is an axial cross-sectional view of an X-ray generation device 10 and appended X-ray spectroscopic device 100 (“spectroscopic device”) according to an embodiment of the present disclosure. As shown, the X-ray generation device 10 includes an internal axially-extending anode 15 having lasing material 20 at some known pressure. Initially, Bremsstrahlung X-rays are generated when high-energy electrodes strike the anode 15 and flood its interior.

This causes total ionization within the anode 20. When the ions recombine with free electrons, characteristic radiation is released corresponding to the electron populations of the shells. Some portion of this characteristic radiation strikes other atoms causing the release of stimulated radiation. This process is repeated over and over as the pumping wave travels the length of the electron gun, ultimately producing a beam of monochromatic radiation with a small angle of divergence. This process is described in commonly-owned U.S. Patent Nos. 8,019,047 and 9,406,478.

X-rays generated within the anode travel axially, with some degree of divergence down the length of the anode into the housing 105 of the spectroscopic device through a window 110. A vacuum seal is maintained separating the X-ray generation device 10 from the spectroscopic device by sealing flanges 112. The housing 105 is formed from highly impermeable materials and techniques are employed to ensures that the interior of the housing 105 remains in a clean state, as determined by the processing protocols during manufacture. The temperature of the housing 105 is maintained by an external cooling and heating system (not shown) that maintains the housing at a constant temperature. This temperature is regulated by a feedback loop using an electronic controller such as a PID (proportional integral derivative) controller. A host computer can also be used to implement closed loop control with suitable programming and configuration. To further ensure dimensional stability, the components of the X-ray spectroscopic device are constructed using low-thermal expansion alloys such as Invar 36 (product of Carpenter Technology Corp. of Philadelphia, PA) and low thermal expansion glass/ceramics such as Zerodur.

The interior of the housing 105 is maintained at a high vacuum. The interior space of the anode is maintained at a desired pressure of the lasing material. The X-ray beam generated by this process enters through window 110 and then crosses to a diffractive element 115 which is mounted on a highly-stable adjustable precision structure 118, referred to herein as a “precision adjustment mount” having multiple axes of freedom for precise angular and dimensional location of the diffractive element. The fine adjustment enabled by precision adjustment mount 118 provides the ability to precisely isolate a specific desired spectral line. The preferred means of achieving such precision motions is the used of piezo-electric nano-positioning units. It is noted that there are other types of devices which are capable providing the necessary control over motion. Once the general alignment of the diffractive element 115 is accomplished, the variable aperture 120 of the spectroscopic device is partially closed to block unwanted portions of the dispersed beam coming off of the diffractive element. The desired portion of the output beam 125 then emerges through a second window 130. It is noted that depending on the system to which the present invention is attached, one or both windows may be advantageously omitted. Portions of the original X-ray energy that emerges from the diffractive element 115 at angles substantially different from the desired spectral line (e.g., 0.001° to 45° divergent) are directed toward a beam dump 135 at a distal end of the housing 105 which is secured to the housing via addition vacuum flanges 138.

The alignment of the precision adjustment mount 118 is controlled by an electrical drive with feedthroughs (not shown) in order to control the alignment while the system is under vacuum (or helium fill). The electrical feedthroughs can go through the wall of the housing 105 and/or direct mechanical adjustment can be implemented using via rotary vacuum fittings which connect the precision adjustment mount 118 with external controls.

While the thermal control aids in maintaining the stability of the shape and position of the diffractive element 115, the precision positioning of the diffractive element stability is augmented by an interferometric system. that measures the dimensions of the diffractive element, continually or periodically at short intervals, and provides feedback to the positioning system to maintain the accurate positioning of the diffractive element 115. The interferometric system are preferably implemented using common path interferometers which are insensitive to vibration. The interferometers can be incorporated into the adjustable mount 118 which performs the X. Y, and Z translations of the diffractive element.. The piezoelectric nanoactuators are also located in these stages. The entirety of the apparatus (both the X-ray generation device and X-ray spectroscopic device) is placed in an insulated jacket to further thermally isolate it from the operating environment.

The windows 112, 130 of the spectroscopic device 100 can comprise differential gas windows (DGWs) in order to control and minimize scatter. These windows can be employed when helium is used as the fill material for the housing (as opposed to operating in a vacuum in which the differential window is inoperative). When this mode of operation is desired, a Residual Gas Analyzer (RGA) can be used to control the ratio of lasant to helium at the interface plane of the DGW.

The methods described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium.

Certain of the modules described herein can communicate with other modules and/or devices (e.g., databases) using data connections over a data network. Data connections can be any known arrangement for wired (e.g., high-speed fiber) or wireless data communication, using any suitable communication protocol, as known in the art.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising", when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of "including," "comprising," or "having," "containing," "involving," and variations thereof herein, is meant to encompass the items listed thereafter and equivalents thereof as well as additional items.

While the invention has been described with reference to exemplary embodiments, it will be understood by those skilled in the art that various changes can be made and equivalents can be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claim.

What is claimed is:

1. An X-ray spectrographic apparatus for providing a high-precision desired spectral line of X-radiation comprising:
a housing coupled to an X-ray generation device, the housing including:
an input window for receiving an X-ray beam from an X-ray generation device;
an adjustable diffractive element positioned to receive the X-ray beam from the
input window and to diffract the X-ray beam such that a substantial portion of the X-ray
beam is directed along a defined orientation associated with the desired spectral line;
a variable aperture positioned with respect to the diffractive element along the
defined orientation so as to receive and pass the portion of the X-ray beam diffracted
along the defined orientation of the desired spectral line and to block X-rays that are not
of the desired spectral line;
an output window positioned opposite from the aperture with respect to the
diffractive element so as to receive the X-ray beam that travels through the aperture; and
an adjustable mount for holding and positioning the diffractive element.

2. The X-ray spectrographic apparatus of claim 1, further comprising a beam dump for
absorbing portions of the input X-ray beam that are not directed toward the aperture.

3. The X-ray spectrographic apparatus of claim 2, wherein the apparatus is coupled to a cooling
system that uses circulating cooling liquid to regulate temperature of the diffractive element, the
variable aperture, the input window, the output window, the beam dump.

4. The X-ray spectrographic apparatus of claim 1, further comprising a drive system for
adjusting the adjustable mount so as to adjust at least one of a position and orientation of the
diffractive element.

5. The X-ray spectrographic apparatus of claim 4, wherein the spectrographic apparatus is
further coupled to an interferometric system that detects changes in the position or orientation of
the diffractive element and is operative to send signals to the drive system to adjust the position
or orientation of the diffractive element to maintain the alignment of the diffractive element with
respect to the aperture.

6. The X-ray spectrographic apparatus of claim 4, wherein the housing is filled with helium gas
and the input window and output window comprise differential gas windows.

7. A method for providing a high-precision desired spectral line of X-radiation comprising:
receiving an X-ray beam from an X-ray generation device;
diffracting the received X-ray beam using a diffractive element, such that a substantial
portion of the X-ray beam is directed along an orientation associated with the desired spectral
line;
precisely adjusting an alignment of the diffractive element;
receiving the X-ray beam directed along the orientation associated with the desired spectral line at a variable aperture;
blocking parts of the X-ray beam that are not precisely of the spectral line at the by
adjusting an opening and position of the aperture;
outputting the desired spectral line; and
regulating a temperature of the diffractive element, variable aperture and beam dump to
preserve dimensions and alignment.

8. The method of claim 7, further comprising:
detecting changes in a position or orientation of the diffractive element; and
sending signals to adjust the position or orientation of the diffractive element to maintain
the alignment of the diffractive element based on detected changes.
